(19) United States
(12) Patent Application Publication
(10) Pub. No.: US 2017/0282424 A1
(43) Pub. Date: Oct. 5, 2017

(54) METAL-RESIN COMPOSITE AND METHOD OF PREPARING THE SAME AND SHELL OF ELECTRONIC PRODUCT

(71) Applicant: BYD COMPANY LIMITED, SHENZHEN (CN)

(72) Inventors: XIAO ZHANG, SHENZHEN (CN); LETIAN TAO, SHENZHEN (CN); JIAN SUN, SHENZHEN (CN); LIANG CHEN, SHENZHEN (CN)

(21) Appl. No.: 15/626,473

(22) Filed: Jun. 19, 2017

Related U.S. Application Data
(63) Continuation of application No. PCT/CN2015/093247, filed on Oct. 29, 2015.

(30) Foreign Application Priority Data
Dec. 25, 2014 (CN) 201410821840.4

(51) Int. Cl. B29C 45/14; C23F 1/38

(52) U.S. Cl. CPC B29C 45/14311; C23F 1/38; B29C 2045/14868; B29K 2705/08

(57) ABSTRACT

The present disclosure provides a metal-resin composite and a method of preparing the same. The metal includes titanium or titanium alloy, the composite includes a metal substrate and a resin layer coated on at least a part of a surface of the metal substrate, recesses are distributed on the part of the surface of the metal substrate coated with the resin layer, a part of resin of the resin layer extends to fill in the recesses, and a concentration of an oxygen element on the surface of the metal substrate is greater than 1 wt %. The method includes dipping a metal substrate in an etching solution containing at least one alkali metal hydroxide so as to form recesses on the surface of the metal substrate, and injecting a resin onto the surface of the after-surface-treatment metal substrate to form a resin layer. The metal-resin composite of the present disclosure is suitable for a shell of an electronic product.

### CROSS-REFERENCE TO RELATED APPLICATIONS

This application is a continuation application of International Application No. PCT/CN2015/093247, filed on Oct. 29, 2015, which is based on and claims priority to and benefits of Chinese Patent Application No. 201410821840.4, filed with the State Intellectual Property Office (SIPO) of the People's Republic of China on Dec. 25, 2014. The entire contents of the above-identified applications are incorporated herein by reference.

### FIELD

Examples of the present disclosure generally relate to a metal-resin composite and a method of preparing the same, and also relates to a shell of an electronic product.

### BACKGROUND

In a component manufacturing field of automobiles, household appliances, industrial machinery, etc., a method of molding metal and resin in an integrated manner is needed.

Currently, a commonly used method of combining titanium material and resin is an adhesive method. This method combines titanium material and resin via an adhesive to obtain a composite. However, a combination force between the titanium material and the resin of the composite obtained from this method may be relatively low, and the adhesive layer is not resistant to acid and alkali, which may affect applications of the composite. In addition, since the adhesive layer may have a certain thickness, a size of a final product may be affected.

To overcome the above disadvantages of the adhesive method, researchers have developed various kinds of methods for combining titanium material and resin.

A CN patent application (Publication No. CN102794863A) disclosed a composite of titanium or titanium alloy and plastic and a method of preparing the same. The method is performed by subjecting a titanium or titanium alloy substrate to an anodic oxidation treatment to form a nano-porous oxidation film on the surface of the titanium or titanium alloy substrate, and then placing the titanium or titanium alloy substrate after anodic oxidation treatment in an injection molding mold to combine a plastic member with the nano-porous oxidation film so as to obtain a composite.

Another CN patent application (Publication No. CN102794864A) disclosed a composite of titanium or titanium alloy and plastic and a method of preparing the same. The method is performed by subjecting a titanium or titanium alloy substrate to an electrochemical cathode processing to form a hydrogenated titanium layer on the surface of the titanium or titanium alloy substrate, subjecting the titanium or titanium alloy substrate with the hydrogenated titanium layer to an anodic oxidation treatment to form a nano-porous oxidation film on the surface of the titanium or titanium alloy substrate, and then placing the titanium or titanium alloy substrate after anodic oxidation treatment in an injection molding mold to combine a plastic member with the nano-porous oxidation film so as to obtain a composite.

However, a pore of the oxidation film formed by an anodic oxidation treatment is a nanopore, the pore is relatively small and the oxidation film is relatively thin, which may cause that a depth of the nanopore is not sufficient, and resulting in a bad combination force between the metal substrate and the resin layer and a bad practicability of the finally obtained composite.

Another CN patent (Patent No. CN101578170B) disclosed a composite of metal and resin, and a method of preparing the same. The method adopts a chemical etching process to perform a surface treatment to a titanium alloy substrate, and then a resin composition is injected on the surface of the substrate after the surface treatment so as to obtain the composite. A chemical etching agent of the method may be hydracids, sulfuric acid, high-temperature phosphoric acid aqueous solution, hydrofluoric acid and ammonium bifluoride, preferably ammonium bifluoride.

Inventors of the present disclosure found during a practical process that: when adopting acid as an etching agent to chemically etch the surface of the titanium material and then injection molding a resin to form a composite, a combination force between the titanium material and the resin may still need to be further improved.

### SUMMARY

The present disclosure seeks to solve the problem that a combination force between the metal substrate and the resin layer of a composite of titanium or titanium alloy and resin in prior art may be low, and thus provides a metal-resin composite and a method of preparing the same. A combination force between the metal substrate and the resin layer of the metal-resin composite may be relatively high.

According to a first aspect of the present disclosure, a metal-resin composite is provided, the metal includes titanium or titanium alloy, the composite includes a metal substrate and a resin layer coated on at least a part of a surface of the metal substrate, recesses are distributed on the part of the surface of the metal substrate coated with the resin layer, a part of the resin of the resin layer extends to fill in the recesses, and a concentration of an oxygen element on the surface of the metal substrate is greater than 1 wt %.

According to a second aspect of the present disclosure, a method of preparing a metal-resin composite is provided, the metal includes titanium or titanium alloy, the method includes an etching step and an injection molding step:

in the etching step, a metal substrate is dipped in an etching solution so as to form recesses on the surface of the metal substrate to obtain an after-surface-treatment metal substrate, the etching solution includes at least one alkali metal hydroxide, a concentration of an oxygen element on the surface of the after-surface-treatment metal substrate is greater than 1 wt %;

in the injection molding step, a composition containing a resin is injected onto the surface of the after-surface-treatment metal substrate so as to fill a part of the composition into the recesses and to form a resin layer after molding.

According to a third aspect of the present disclosure, a metal-resin composite prepared by the method stated above is provided.

According to a fourth aspect of the present disclosure, a shell of an electronic product is provided, the shell includes a metal shell body and a resin member coated on at least a part of an inner surface and/or at least a part of an outer surface of the metal shell body, the metal shell body is made of titanium or titanium alloy, wherein recesses are distributed on a surface of the metal shell body coated with the resin member, a part of resin in the resin member fills in the recesses, a concentration of an oxygen element on the surface of the metal shell body coated with the resin member is greater than 1 wt %.

With the metal-resin composite of the present disclosure, the combination force between the metal substrate and the resin layer may be high, the resin layer does not fall off from the surface of the metal substrate easily, the metal-resin composite has a good structure stability, and thus could satisfy requirements of various applications and suitable for various electronic product shells.

With the method of preparing metal-resin composite of the present disclosure, an etching agent includes an alkali metal hydroxide. Compared with a surface treatment using an acid etching liquid, with the method of the present disclosure, on one hand, densely distributed recesses may be formed on the surface of the metal substrate; on the other hand, destruction corrosion does not occur on the surface of the metal substrate, thus the obtained after-surface-treatment metal substrate may still have a relatively high strength. In addition, by etching the metal substrate and injection molding resin onto the surface of the after-surface-treatment metal substrate to form the metal-resin composite via the method of the present disclosure, a combination strength between the metal substrate and the resin layer may be relatively high. This is because that densely distributed recesses having relatively homogeneous size is formed on the surface of the after-surface-treatment metal substrate when etching the metal substrate via the method of the present disclosure, which may anchor the resin layer in the metal substrate. Moreover, a high concentration of the oxygen element exists on the surface of the after-surface-treatment metal substrate. In other words, not all of oxygen elements exist in the form of a metallic oxide, and a portion of the oxygen elements exist in the form of hydroxyl, which may interact with resin when combined with resin. Thus, the final obtained metal-resin composite may have a higher combination strength between the metal substrate and the resin layer.

In addition, the etching solution used in the method of the present disclosure has a low poisonousness and low volatility, thus operation of the method is safer and produces less pollution to the environment.

Besides, the constituent of the etching solution used in the method of the present disclosure may be selected from abroad sources at a lower price, which may reduce an operation cost of the method. Thus, the method of the present disclosure may be suitable for a mass production.

### BRIEF DESCRIPTION OF THE DRAWINGS

FIG. 1 is a sectional view of a cell phone shell according to one example of the present disclosure, including a front view and a top view.

FIG. 2 is a sectional view of a shell of an intelligent watch according to one example of the present disclosure.

### REFERENCE NUMBER

| | |
|---|---|
| 1: cell phone metal shell body 1 | 2: resin layer |
| 3: opening | 4: intelligent watch shell body |
| 5: resin inside liner | 6: signal element opening |

### DETAILED DESCRIPTION

Reference will be made in detail to examples of the present disclosure. The examples described herein are explanatory and illustrative, which are used to generally understand the present disclosure. The examples shall not be construed to limit the present disclosure.

According to a first aspect of the present disclosure, a metal-resin composite is provided. The composite includes a metal substrate and a resin layer coated on at least a part of a surface of the metal substrate, recesses are distributed on the part of the surface of the metal substrate coated with the resin layer, a part of resin of the resin layer extends to fill in the recesses.

According to the metal-resin composite of the present disclosure, the metal may include pure titanium, and the metal may also include titanium alloy. The titanium alloy refers to an alloy which includes a basic element of titanium element and is formed by adding other element, and the titanium alloy could be any common titanium alloy. The metal substrate may be various molding products made of titanium or titanium alloy, and the metal substrate may have various shapes depending on using situation of the final prepared metal-resin composite, there is no particular limitation for the shape of the metal substrate.

The recesses are distributed on the surface of the metal substrate coated with the resin layer, the recesses are densely distributed on the surface of the metal substrate. The recesses may be formed by chemical etching the surface of the metal substrate. A part of resin of the resin layer fills in the recesses so as to anchor the resin layer in the metal substrate. In some embodiments of the present disclosure, each recess may have a width of about 10 nanometers to about 100000 nanometers and a depth of about 10 nanometers to about 5000 nanometers. When the size of the recesses are within the above range, on one hand, it does not bring a negative influence to the strength of the metal substrate; on the other hand, the resin layer may be firmly anchored in the metal substrate, such that a relatively high combination force between the resin layer and the metal substrate may be obtained, and the metal-resin composite may have a relatively high structure stability. From a perspective of further improving the combination force between the resin layer and the metal substrate, the width of the recesses are preferably about 300 nanometers to about 30000 nanometers, and the depth of the recesses are preferably about 100 nanometers to about 3000 nanometers. In some embodiments of the present disclosure, “width of the recess” refers to a maximum distance between two points on a contour line determined by a port of the recess on the surface of the metal substrate, and “depth of the recess” refers to a vertical distance between the port of the recess on the surface of the metal substrate and the bottom of the recess. The width and depth of the recess could be measured via an electron microscopic observation method.

According to the metal-resin composite, the concentration of an oxygen element on the surface of the metal substrate is greater than 1 wt %. Compared with the concentration of the oxygen element on the surface of the metal substrate lower than 1 wt %, when the concentration of the oxygen element on the surface of the metal substrate is greater than 1 wt %, a combination strength between the resin layer and the metal substrate of the composite may be obviously improved. Preferably, the concentration of the oxygen element on the surface of the metal substrate is about 1 wt % to about 10 wt %, more preferably about 2 wt % to about 8 wt %, and further more preferably about 5 wt % to about 7 wt %. An element composition on the surface of the metal substrate could be measured through an energy spectrum analytical method, and a percentage of the quantity of the oxygen element to the total quantity of the element composition on the surface of the metal substrate is defined as the concentration of the oxygen element on the surface of the metal substrate.

The main resin in the resin layer could be selected depending on a specific using requirement, as long as the resin could be combined with the titanium or titanium alloy. Generally, the main resin in the resin layer could be selected from thermoplastic resin, such as polyphenylene sulfide, polyester, polyamide, polycarbonate, polyolefin and combinations thereof. The polyester may be common polymer that is formed through condensation of dicarboxylic acid and diol, and the specific examples may include, but not limited to, polybutylene terephthalate and/or polyethylene glycol terephthalate. The polyamide could be common polymer that is formed through condensation of diamine and dicarboxylic acid, and specific examples may include, but not limited to, polyhexamethylene adipamide (PA66), polynonylhexylenediamine (PA69), polybutyl diacylenediamin, polyhexamethylene dodecanamide (PA612), poly(hexamethylene sebacamide) (PA610), poly(decamethylene sebacamide) (PA1010), polyundecaneamid (PA11), polylauramide (PA12), polycaprylamide (PA8), poly(9-amino nonanoic acid) (PA9), polycaprolactam (PA6), poly(p-phenylene terephthalamide), polyphenyldimethylenediamine, polyhexamethylene terephthalamide (PA6T) and polynonamethylene terephthalamide (PAST). Specific examples of the polyolefin may include, but not limited to, polystyrene, polypropylene, polymethyl methacrylate, and poly (acrylonitrile-butadiene styrene).

Besides the main resin, the resin layer may further include at least one kind of filler. The filler may be selected depending on a specific using requirement. The filler may include a fiber filler and/or powder filler. The fiber filler may be at least one selected from a group consisting of glass fiber, carbon fiber and aromatic polyamide fiber. The powder filler may be at least one selected from a group consisting of calcium carbonate, magnesium carbonate, silicon dioxide, heavy barium sulfate, talcum powder, glass and clay. The concentration of the filler may be determined by a common selection. Generally, per100 weight parts of the main resin, the filler has a concentration of about 10 weight parts to about 150 weight parts, preferably about 15 weight parts to about 100 weight parts, more preferably about 20 weight parts to about 50 weight parts.

A thickness of the metal substrate and the resin layer may be selected according to a specific using situation of the metal-resin composite, as long as the metal-resin composite could satisfy using requirements. Generally, in some embodiments, the resin layer has a thickness of about 0.5 millimeters to about 10 millimeters.

According to a second aspect of the present disclosure, a method of preparing a metal-resin composite is provided, the metal includes titanium or titanium alloy, the method includes an etching step and an injection molding step.

In the etching step, a metal substrate is dipped in an etching solution so as to form recesses on a surface of the metal substrate to obtain an after-surface-treatment metal substrate, the etching solution includes at least one alkali metal hydroxide.

According to the method of the present disclosure, after the etching step, the recesses are formed on the surface of the obtained after-surface-treatment metal substrate, the recesses are densely distributed on the surface of the metal substrate. Each recess has a width of about 10 nanometers to about 100000 nanometers, preferably about 300 nanometers to about 30000 nanometers, and a depth of about 10 nanometers to about 5000 nanometers, preferably about 100 nanometers to about 3000 nanometers.

According to the method of the present disclosure, a concentration of an oxygen element on the surface of the after-surface-treatment metal substrate is greater than 1 wt %, preferably about 2 wt % to about 8 wt %, more preferably about 5 wt % to about 7 wt %.

According to the method of the present disclosure, the etching solution includes as least one kind of alkali metal hydroxide.

In some embodiments, the alkali metal hydroxide includes sodium hydroxide and/or potassium hydroxide.

A concentration of the alkali metal hydroxide in the etching solution could be selected according to an expected etching speed. Preferably in the etching solution, the alkali metal hydroxide has a concentration of about 1 mol/L to about 10 mol/L. When the concentration of the alkali metal hydroxide is within the above range, not only densely distributed recesses could form on the surface of the metal substrate, but also a destruction to the metal substrate may be smaller. More preferably, in the etching solution, the alkali metal hydroxide has a concentration of about 5 mol/L to about 8 mol/L.

Preferably, the etching solution may include at least one kind of buffering agent. Although densely distributed recesses may be formed on the surface of the metal substrate when the etching solution does not include a buffering agent, when the etching solution includes a buffering agent, a concentration of hydroxide ion in the etching solution may be stabilized within a certain range during a relatively long period. Thus, a stable etching effect may be obtained, which may not only satisfy a requirement of a mass production, but may also further improve a combination force between the metal substrate and the resin layer of the final obtained metal-resin composite.

In some embodiments of the present disclosure, the buffering agent could be any common materials that could stabilize the concentration of the hydroxide ion in the etching solution. Preferably, the buffering agent is at least one selected from a group consisting of boric acid, sodium borate, sodium carbonate, sodium hydrogen carbonate, trisodium phosphate, disodium hydrogen phosphate, and sodium citrate.

A concentration of the buffering agent may be selected as long as the concentration of hydroxide ion in the etching solution could be stabilized within an expect range. Preferably, the buffering agent has a concentration of about 0.1 mol/L to about 1.5 mol/L, more preferably, the buffering agent has a concentration of about 0.2 mol/L to about 1 mol/L.

A solvent of the etching may be determined by common selections, generally the solvent could be water.

The etching solution has a temperature of about 15 Celsius degrees to about 70 Celsius degrees. From a perspective of further improving the combination strength between the metal substrate and the resin layer of the metal-resin composite, the etching solution has a temperature of about 15 Celsius degrees to about 35 Celsius degrees. From a perspective of further improving the etching speed and reducing a time of dipping the metal substrate in the etching solution so as to reduce the influence caused by the etching to appearance and size of the metal substrate, the etching solution has a temperature of about 40 Celsius degrees to about 70 Celsius degrees.

The dipping time of the metal substrate in the etching solution could be determined according to the concentration and temperature of the etching solution. Generally, the metal substrate may be dipped in the etching solution for about 10 minutes to about 5 hours, preferably for about 30 minutes to about 2 hours.

The number of times of dipping the metal substrate in the etching solution and the dipping time of the metal substrate in the etching solution could be determined according to the constitution of the etching solution and the temperature of the etching solution. Generally, the metal substrate may be dipped in the etching solution for one time, or the metal substrate may be dipped in the etching solution for several times, for example 2 to 10. After each time of dipping, generally, the metal substrate is washed by water (preferably deionized water) so as to remove the etching solution attached on the after-surface-treatment metal substrate. The number of times of washing may be 2 to 10. The method of washing may be dipping the after-surface-treatment metal substrate in water for about 1 minute to about 5 minutes, and the method of washing may also be flushing the after-surface-treatment metal substrate by water for about 1 minute to about 5 minutes.

According to the method of the present disclosure, the etching step may be performed on the whole surface of the metal substrate or on a part of the surface of the metal substrate. When the etching step is performed on a part of the surface of the metal substrate, it could be dipping only the part of the surface of the metal substrate which needs to be etched in the etching solution; it could also be forming a shielding mask on the other part of the surface of the metal substrate which does not need to be etched and then dipping the whole metal substrate in the etching solution.

Comparing the after-surface-treatment metal substrate with the metal substrate before being etched, only recesses are distributed on the surface and a color of surface of the metal substrate is deepened for the after-surface-treatment metal substrate, and the size of the metal substrate does not change much. In addition, a corrosion depth of the after-surface-treatment metal substrate obtained from the method of the present disclosure may be shallow, which may be liable to remove the recesses and color change on the surface region of the metal substrate that do not need to form resin layer thereon, such that the final obtained composite may have a good appearance.

According to the method of the present disclosure, in the injection molding step, a composition containing a resin is injected onto the surface of the after-surface-treatment metal substrate so as to fill a part of the composition into the recesses and to form a resin layer after molding.

The resin (namely the main resin here below) in the resin-containing composition could be selected according to a specific using requirement, as long as the resin could be combined with the titanium or titanium alloy. Generally, the main resin in the resin layer could be selected from thermoplastic resin, such as polyphenylene sulfide, polyester, polyamide, polycarbonate, polyolefin and combinations thereof. The polyester may be common polymer that formed through condensation of dicarboxylic acid and diol, the specific examples may include, but not limited to, polybutylene terephthalate and/or polyethylene glycol terephthalate. The polyamide could be common polymer that formed through condensation of diamine and dicarboxylic acid, the specific examples may include, but not limited to, polyhexamethylene adipamide (PA66), polynonylhexylenediamine (PA69), polybutyl diacylenediamin, polyhexamethylene dodecanamide (PA612), poly(hexamethylene sebacamide) (PA610), poly(decamethylene sebacamide) (PA1010), polyundecaneamid (PA11), polylauramide (PA12), polycaprylamide (PA8), poly(9-amino nonanoic acid) (PA9), polycaprolactam (PA6), poly(p-phenylene terephthalamide), polyphenyldimethylenediamine, polyhexamethylene terephthalamide (PA6T) and polynonamethylene terephthalamide (PAST). The specific examples of the polyolefin may include, but not limited to, polystyrene, polypropylene, polymethyl methacrylate, and poly (acrylonitrile-butadiene styrene).

Besides the main resin, the resin-containing composition may further include at least one kind of filler and/or one kind of fluidity improver.

The filler may be selected depending on a specific using requirement. The filler may include a fiber filler and/or powder filler. The fiber filler may be at least one selected from a group consisting of glass fiber, carbon fiber and aromatic polyamide fiber. The powder filler may be at least one selected from a group consisting of calcium carbonate, magnesium carbonate, silicon dioxide, heavy barium sulfate, talcum powder, glass and clay.

The concentration of the filler may be determined by common selections. Generally, per100 weight parts of the main resin, the filler has a concentration of about 10 weight parts to about 150 weight parts, preferably about 15 weight parts to about 100 weight parts, more preferably about 20 weight parts to about 50 weight parts.

The fluidity improver is used to improve a fluid ability of the main resin, further improve the combination force between the metal substrate and the resin, and improve a machining performance of the resin. The fluidity improver could be any material that could realize these effects above, preferably the fluidity improver includes a ring polyester.

The concentration of the fluidity improver may be determined based on the ability of the fluidity improver improving the fluid ability of the main resin. Preferably, per100 weight parts of the main resin, the fluidity improver has a concentration of about 1 weight part to about 5 weight parts.

The resin-containing composition may further include various common assistants depending on the specific using requirement, such as colorant and/or antioxidant, so as to improve performance of the resin layer or add new functions to the resin layer.

The resin-containing composition may be obtained by evenly mixing the main resin, a selected filler, a selected fluidity improver and a selected assistant. Generally, the resin-containing composition is obtained by evenly mixing the main resin, the selected filler, the selected fluidity improver and the selected assistant and then performing extrusion pelletizing.

The resin-containing composition may be injected on the surface of the metal substrate via various commonly used methods. In one embodiments of the present disclosure, the after-surface-treatment metal substrate is placed in a mold, and then the resin-containing composition is injected on the surface of the metal substrate after treatment via injection molding.

A condition of the injection molding could be selected according to a category of the main resin in the resin-containing composition. Preferably, the condition of the injection includes: a temperature of mold is about 50 Celsius degrees to about 300 Celsius degrees, a temperature of nozzle is about 200 Celsius degrees to about 450 Celsius degrees, a time of maintaining pressure is about 1 second to about 50 seconds, an injection pressure is about 50 Mpa to about 300 Mpa, an injection time is about 1 second to about 30 seconds, and a relay time is about 1 second to about 30 seconds.

An amount of the injected resin-containing composition could be selected according to an expected thickness of the resin layer. Generally, the amount of the injected resin-containing composition forms a resin layer having a thickness of about 0.5 millimeters to about 10 millimeters.

With the method of the present disclosure, when the resin layer is only formed on a part of the surface of the metal substrate, the other part of the surface of the metal substrate where a resin layer does not need to form thereon could be processed to remove the recesses thereon and color variance caused by etching. This process could be done before or after the injection molding step, there is no particular limitations in the present disclosure.

According to a third aspect of the present disclosure, a metal-resin composite prepared by the method stated above is provided. The metal-resin composite prepared by the method of the present disclosure includes a metal substrate and a resin layer coated on at least a part of the surface of the metal substrate, recesses are distributed on the part of the surface of the metal substrate coated with the resin layer, a part of the resin of the resin layer extends to fill in the recesses.

According to some embodiments of the metal-resin composite prepared by the method of the present disclosure, a combination force between the resin layer and the metal substrate is high, and then a structure stability of the composite is good.

The metal-resin composite of the present disclosure could be applied to various situations that need to mold metal and resin in an integrated manner, such as an electronic product shell. In a specific application, the metal may be molded into different shapes, and the surface of the metal that need to form a resin layer thereon should be subjected to a surface treatment, and then the resin is injection molded so as to form the resin layer.

Thus, according to a fourth aspect of the present disclosure, a shell of an electronic product is provided. The shell includes a metal shell body and a resin member coated on at least a part of an inner surface and/or at least a part of an outer surface of the metal shell body, the metal shell body is made of titanium or titanium alloy, recesses are distributed on the surface of the metal shell body coated with the resin member, a part of resin in the resin member fills in the recesses. In some embodiments of the present disclosure, the shell could have a sheet structure, and also the shell could have a frame structure, such as a surrounding frame.

The recesses may have a width of about 10 nanometers to about 100000 nanometers, preferably about 300 nanometers to about 30000 nanometers, and the recesses may have a depth of about 10 nanometers to about 5000 nanometers, preferably about 100 nanometers to about 3000 nanometers.

A concentration of an oxygen element on the surface of the metal shell body coated with the resin member is greater than 1 wt %, preferably about 1 wt % to about 10 wt %, preferably about 2 wt % to about 8 wt %, more preferably about 5 wt % to about 7 wt %.

According to embodiments of the shell of an electronic product of the present disclosure, depending on specific needs, more than one opening may be formed on the metal shell body, so as to install a member of the electronic product, that need to be kept off from the metal shell on a corresponding position of the opening. In one embodiment, due to a signal shielding effect that caused by the metal, at least a portion of the opening is corresponding to an installation position of a signal (such as electromagnetic signal) emitting member and/or a signal (such as electromagnetic signal) receiving member. Then a resin member is preferably disposed on the position of the opening, a part of the resin member is filled in the opening. That is, the part of resin of the resin member is filed in the opening, and the signal emitting member and/or a signal receiving member may be disposed on the resin member.

According to some embodiments of the shell of an electronic product of the present disclosure, the metal shell body may be an integrated structure, and also the metal body may be a splicing structure. The splicing structure suggests that the metal shell body includes at least two segments separated from each other, and the two segments are spliced together to form the metal shell body.

When the metal shell body is a splicing structure, two adjacent segments may be fixed together via an adhesive. In some embodiments, the resin member is disposed on a joint position of two adjacent segments, the resin member is lap jointed to the two adjacent segments respectively and covers the joint position (namely the two adjacent segments are bridge connected via the resin member), then a combination strength of the joint position may be improved. In addition, the metal shell body may be divided into several segments depending on an inner structure of the electronic product, the resin member may not only function to make the metal shell to form a whole part, but also may function as an installation base of some electronic elements.

According to some embodiments of the shell of an electronic product, the resin member may be coated on at least a part of an outer surface of the metal shell body. The resin member may be coated on the entire outer surface of the metal shell body and may also be coated on a part of outer surface of the metal shell body to form a pattern on the outer surface of the metal shell body, for example a decorative pattern.

According to some embodiments of the shell of an electronic product of the present disclosure, when an inner surface of the metal shell body is coated with a resin member, the resin member may be disposed on one or more needed position. In one embodiment, the resin member is coated on entire inner surface of the metal shell body, then the resin member preferably is an integrated structure. In some embodiments, it is suitable to an application that the metal shell body is a splicing structure.

According to some embodiments of the shell of an electronic product of the present disclosure, the shell of an electronic product could be used as shell of various electronic product which needs a metal shell, for example: a shell or a surrounding frame of mobile terminals, or a shell or a surrounding frame of wearable electronic devices. A mobile terminal refers to a device that could be in a moving state and has a function of wireless communication, such as: mobile phone, and a portable computer (including notebook computer and tablet computer). The wearable electronic device refers to an intelligent wearable device, such as an intelligent watch, an intelligent bracelet. The electronic product may be, but not limited to, a mobile phone, a portable computer (such as notebook computer and tablet computer), an intelligent watch, or an intelligent bracelet.

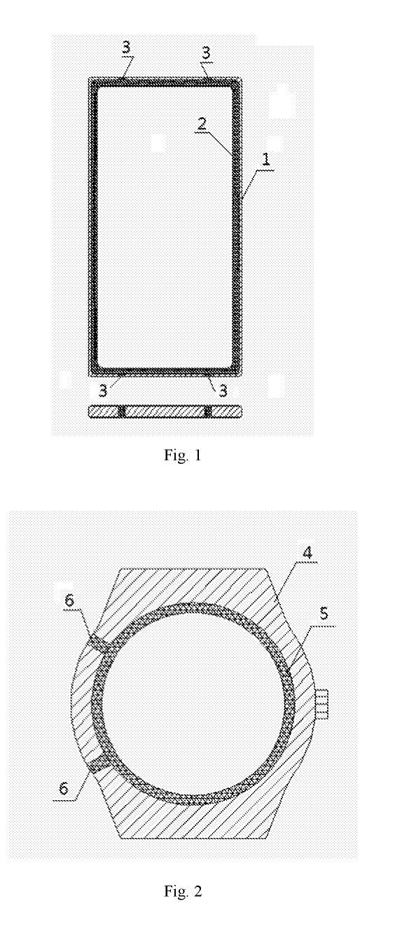

FIG. 1 is a front view and a top view of an example that when the shell of an electronic product is used as a cell phone shell. As shown in FIG. 1, several openings 3 is disposed on the cell phone metal shell body 1, the position of the openings is corresponding to an installation position of antenna and various buttons. A resin layer 2 is coated on the entire inner surface of the cell phone metal shell body 1, and the resin layer 2 is an integrated structure and a part of resin in the resin layer 2 is filled in the opening 3.

FIG. 2 is a front view of an example that when the shell of an electronic product is used as a shell of an intelligent watch. As shown in FIG. 2, an signal element opening 6 that corresponding to install a signal emitting and/or a signal receiving member is disposed on the intelligent watch shell body 4. A resin inside liner 5 is coated on an inner surface of the intelligent watch shell body 4, a part of the resin of the resin inside liner 5 is filled in the signal element opening 6, and signal elements could be installed on a position corresponding to the resin inside liner 5.

The present disclosure will be given detailed description combining with Examples, these Examples should not be constructed to limit the scope of the present disclosure.

In Examples and Comparative Examples below, an average shearing strength between the metal substrate and the resin layer of the metal-resin composite is tested on a 3369 universal testing machine purchased from INSTRON in a stretching mode. A ratio of a tensile stress when the composite is fractured to a combination area is defined as the average shearing strength, the combination area refers to an area of a junction the surface between the metal substrate and the resin layer.

In Examples and Comparative Examples below, a surface of and a fractured surface of the after-surface-treatment metal substrate is observed under a metallographic microscope, and a width and a depth of the recesses are identified. The metallographic microscope is Axio Imager A1m purchased from Zeiss.

In Examples and Comparative Examples below, the concentration of an oxygen element on the surface of the metal substrate is tested via a field emission scanning electron microscopy and its attachment energy disperse spectroscopy, the energy disperse spectroscopy is JSM-7600F purchased from JEOL Ltd. Energy spectrum analysis is performed on 10 selected points on the surface of a tested sample, these 10 selected points is distributed on different position of surface of the tested sample, an average value of the concentration of the oxygen element of these 10 selected points is defined as the concentration of the oxygen element on the surface of the metal substrate.

Examples 1 to 7 are used to illustrate the present disclosure.

### Example 1

### 1. Pre-Treatment

A pure titanium plate sold in market having a thickness of 0.8 millimeters is cut into a rectangle sheet having a size of 15 millimeters*80 millimeters, and then the rectangle sheet is placed in a polishing machine to be polished, and then the rectangle sheet is subjected to, in sequence, oil removing, washing and drying.

### 2. Surface Treatment

A titanium sheet obtained after step (1) is dipped in a 500 mL etching solution for 60 minutes under 25 Celsius degrees. Then the titanium sheet is taken out and washed via deionized water for 3 times, and then placed in an oven to dry under 65 Celsius degrees so as to obtain an after-surface-treatment titanium sheet. The etching solution is a mixed aqueous solution of sodium hydroxide and boric acid, the sodium hydroxide has a concentration of 7 mol/L, and the boric acid has a concentration of 0.5 mol/L.

A surface of the after-surface-treatment titanium sheet is observed under a metallographic microscope, it is identified that densely distributed recesses are formed on the surface of the titanium sheet after the surface treatment, and the recesses have a width in a range of 300 nanometers to 30000 nanometers, and a depth in a range of 100 nanometers to 3000 nanometers. An energy spectrum analysis is performed on the surface of the after-surface-treatment titanium sheet via a scanning electron microscopy so as to measure the concentration of each element and the concentration of an oxygen element on the surface of the after-surface-treatment titanium sheet. The result is recorded in Table 1.

### 3. Injection Molding

The after-surface-treatment titanium sheet obtained after step (2) is placed in a mold, and a composition containing polyphenylene sulfide (PPS) and glass fiber is injection molded into the mold so as to form a resin layer on one surface of the titanium sheet to obtain a metal-resin composite (a thickness of the resin layer is 3 millimeters). Per100 weight parts of the polyphenylene sulfide, the glass fiber has a concentration of 20 weight parts.

In the composite, an average shearing strength between the metal substrate and the resin layer is listed in Table 2.

### Comparative Example 1

(1) A pretreatment of this Comparative Example is performed by using a method same as step (1) of Example 1.

(2) A composition containing polyphenylene sulfide and glass fiber is injection molded onto the surface of the titanium sheet after step (1) by using a method same as step (3) of Example 1 so as to obtain a metal-resin composite. In the composite, an average shearing strength between the metal substrate and the resin layer is listed in Table 2.

### Comparative Example 2

(1) A pretreatment of this Comparative Example is performed by using a method same as step (1) of Example 1.

(2) Surface treatment The titanium sheet obtained after step (1) is dipped in a 500 mL etching solution for 24 minutes under 25 Celsius degrees. Then the titanium sheet is taken out and washed via deionized water for 3 times, and then placed in an oven to dry under 65 Celsius degrees so as to obtain an after-surface-treatment titanium sheet. An average hardness of the titanium sheet is listed in Table 1. The etching solution is a aqueous solution of ammonium bifluoride, the ammonium bifluoride has a concentration of 1 wt %.

A surface of the after-surface-treatment titanium sheet is observed under a metallographic microscope, it is identified that densely distributed recesses are formed on the surface of the after-surface-treatment titanium sheet, and the recesses have a width in a range of 20000 nanometers to 150000 nanometers, and a depth in a range of 1000 nanometers to 10000 nanometers. An energy spectrum analysis is performed on the surface of the after-surface-treatment titanium sheet via a scanning electron microscopy so as to measure the concentration of each element and the concentration of the oxygen element on the surface of the after-surface-treatment titanium sheet. The result is recorded in Table 1.

(3) Injection Molding

A composition containing polyphenylene sulfide and glass fiber is injection molded onto surface of the after-surface-treatment titanium sheet obtained after step (2) using a method same as step (3) of Example 1 so as to obtain a metal-resin composite.

In the composite, an average shearing strength between the metal substrate and the resin layer is listed in Table 2.

### Comparative Example 3

(1) A pretreatment of this Comparative Example is performed by using a method same as step (1) of Example 1.

(2) Surface Treatment

A titanium sheet obtained after step (1) is dipped a 500 mL anodic oxidation electrolyte to perform anodic oxidation. The electrolyte is an aqueous solution of phosphoric acid, the phosphoric acid has a concentration of 10 wt %, the anodic oxidation is performed under a voltage of 20 V, a conduction time of 10 minutes. And then the titanium sheet after anodic oxidation is washed via deionized water for 3 times, and then placed in an oven to dry under 65 Celsius degrees so as to obtain an after-surface-treatment titanium sheet.

(3) Injection Molding

A composition containing polyphenylene sulfide and glass fiber is injection molded onto surface of the after-surface-treatment titanium sheet obtained after step (2) by using a method same as step (3) of Example 1 so as to obtain a metal-resin composite.

In the composite, an average shearing strength between the metal substrate and the resin layer is listed in Table 2.

### Example 2

(1) A pretreatment of this Example is performed by using a method same as step (1) of Example 1.

(2) Surface Treatment

A titanium sheet obtained after step (1) is dipped in a 500 mL etching solution for 30 minutes under 35 Celsius degrees. Then the titanium sheet is taken out and washed via deionized water for 3 times, and then placed in an oven to dry under 65 Celsius degrees so as to obtain an after-surface-treatment titanium sheet. The etching solution is a mixed aqueous solution of sodium hydroxide and disodium hydrogen phosphate, the sodium hydroxide has a concentration of 7 mol/L, and the disodium hydrogen phosphate has a concentration of 1 mol/L.

A surface of the after-surface-treatment titanium sheet is observed under a metallographic microscope, it is identified that densely distributed recesses are formed on the surface of the after-surface-treatment titanium sheet, and the recesses have a width in a range of 300 nanometers to 30000 nanometers, and a depth in a range of 100 nanometers to 3000 nanometers. An energy spectrum analysis is performed on the surface of the after-surface-treatment titanium sheet via a scanning electron microscopy so as to measure the concentration of each element and the concentration of an oxygen element on the surface of the after-surface-treatment titanium sheet. The result is recorded in Table 1.

(3) A composition containing polyphenylene sulfide and glass fiber is injection molded onto surface of the after-surface-treatment titanium sheet obtained after step (2) by using a method same as step (3) of Example 1 so as to obtain a metal-resin composite. Per100 weight parts of the polyphenylene sulfide, the glass fiber has a concentration of 20 weight parts. In the composite, an average shearing strength between the metal substrate and the resin layer is listed in Table 2.

### Example 3

(1) A pretreatment of this Example is performed by using a method same as step (1) of Example 1.

(2) Surface Treatment

A titanium sheet obtained after step (1) is dipped in a 500 mL etching solution for 120 minutes under 15 Celsius degrees. Then the titanium sheet is taken out and washed via deionized water for 3 times, and then placed in an oven to dry under 65 Celsius degrees so as to obtain an after-surface-treatment titanium sheet. The etching solution is a mixed aqueous solution of sodium hydroxide and sodium carbonate, the sodium hydroxide has a concentration of 6 mol/L, and the sodium carbonate has a concentration of 0.2 mol/L.

A surface of the after-surface-treatment titanium sheet is observed under a metallographic microscope, it is identified that densely distributed recesses are formed on the surface of the after-surface-treatment titanium sheet, and the recesses have a width in a range of 300 nanometers to 30000 nanometers, and a depth in a range of 100 nanometers to 3000 nanometers. An energy spectrum analysis is performed on the surface of the after-surface-treatment titanium sheet via a scanning electron microscopy so as to measure the concentration of each element and the concentration of an oxygen element on the surface of the after-surface-treatment titanium sheet. The result is recorded in Table 1.

(3) A composition containing polyphenylene sulfide and glass fiber is injection molded onto surface of the after-surface-treatment titanium sheet obtained after step (2) by using a method same as step (3) of Example 1 so as to obtain a metal-resin composite. Per100 weight parts of the polyphenylene sulfide, the glass fiber has a concentration of 20 weight parts. In the composite, an average shearing strength between the metal substrate and the resin layer is listed in Table 2.

### Example 4

(1) A pretreatment of this Example is performed by using a method same as step (1) of Example 1.

(2) A surface treatment of this Example is performed by using a method substantially same as step (2) of Example 1 is performed on a titanium sheet obtained after step (1) so as to obtain an after-surface-treatment titanium sheet, except for that: the etching solution is an aqueous solution of sodium hydroxide, the sodium hydroxide has a concentration of 7 mol/L.

A surface of the after-surface-treatment titanium sheet is observed under a metallographic microscope, it is identified that densely distributed recesses are formed on the surface of the after-surface-treatment titanium sheet, and the recesses have a width in a range of 10 nanometers to 100000 nanometers, and a depth in a range of 10 nanometers to 5000 nanometers. An energy spectrum analysis is performed on the surface of the after-surface-treatment titanium sheet via a scanning electron microscopy so as to measure the concentration of each element and the concentration of an oxygen element on the surface of the after-surface-treatment titanium sheet. The result is recorded in Table 1.

(3) A composition containing polyphenylene sulfide and glass fiber is injection molded onto surface of the after-surface-treatment titanium sheet obtained after step (2) by using a method same as step (3) of Example 1 so as to obtain a metal-resin composite.

In the composite, an average shearing strength between the metal substrate and the resin layer is listed in Table 2.

### Example 5

(1) A pretreatment of this Example is performed by using a method same as step (1) of Example 1.

(2) A surface treatment of this Example is performed by using a method substantially same as step (2) of Example 1 is performed on a titanium sheet obtained after step (1) so as to obtain an after-surface-treatment titanium sheet, except for that: the etching solution has a temperature of 70 Celsius degrees, and the dipping time is 30 minutes.

A surface of the after-surface-treatment titanium sheet is observed under a metallographic microscope, it is identified that densely distributed recesses are formed on the surface of the after-surface-treatment titanium sheet, and the recesses have a width in a range of 300 nanometers to 30000 nanometers, and a depth in a range of 100 nanometers to 3000 nanometers. An energy spectrum analysis is performed on the surface of the after-surface-treatment titanium sheet via a scanning electron microscopy so as to measure the concentration of each element and the concentration of an oxygen element on the surface of the after-surface-treatment titanium sheet. The result is recorded in Table 1.

(3) A composition containing polyphenylene sulfide and glass fiber is injection molded onto surface of the after-surface-treatment titanium sheet obtained after step (2) by using a method same as step (3) of Example 1 so as to obtain a metal-resin composite.

In the composite, an average shearing strength between the metal substrate and the resin layer is listed in Table 2.

### Example 6

### 1. Pre-Treatment

A pure titanium alloy plate sold in market having a thickness of 0.8 millimeters is cut into a rectangle sheet having a size of 15 millimeters*80 millimeters, and then the rectangle sheet is placed in a polishing machine to be polished, and then the rectangle sheet is subjected to, in sequence, oil removing, washing and drying.

### 2. Surface Treatment

A titanium alloy sheet obtained after step (1) is dipped in a 500 mL etching solution for 60 minutes under 25 Celsius degrees. Then the titanium alloy sheet is taken out and washed via deionized water for 3 times, and then placed in an oven to dry under 65 Celsius degrees so as to obtain an after-surface-treatment titanium alloy sheet. The etching solution is a mixed aqueous solution of potassium hydroxide and sodium citrate, the potassium hydroxide has a concentration of 7 mol/L, and the sodium citrate has a concentration of 0.5 mol/L.

A surface of the after-surface-treatment titanium alloy sheet is observed under a metallographic microscope, it is identified that densely distributed recesses are formed on the surface of the titanium alloy sheet after surface treatment, and the recesses have a width in a range of 300 nanometers to 30000 nanometers, and a depth in a range of 100 nanometers to 3000 nanometers. An energy spectrum analysis is performed on the surface of the titanium alloy sheet after surface treatment via a scanning electron microscopy so as to measure the concentration of each element and the concentration of an oxygen element on the surface of the titanium alloy sheet after surface treatment. The result is recorded in Table 1.

### 3. Injection Molding

The after-surface-treatment titanium alloy sheet obtained after step (2) is placed in a mold, and a composition containing polybutylene terephthalate (PBT) and glass fiber is injection molded into the mold so as to form a resin layer on one surface of the titanium alloy sheet to obtain a metal-resin composite (a thickness of the resin layer is 3 millimeters). Per100 weight parts of the polybutylene terephthalate, the glass fiber has a concentration of 20 weight parts.

In the composite, an average shearing strength between the metal substrate and the resin layer is listed in Table 2.

### Example 7

(1) A pretreatment of this Example is performed by using a method same as step (1) of Example 6.

(2) A surface treatment of this Example is performed by using a method substantially same as step (2) of Example 6 is performed on a titanium alloy sheet obtained after step (1) so as to obtain an after-surface-treatment titanium alloy sheet, except for that: the etching solution has a temperature of 45 Celsius degrees, and the dipping time is 40 minutes.

A surface of the after-surface-treatment titanium alloy sheet is observed under a metallographic microscope, it is identified that densely distributed recesses are formed on the surface of the titanium alloy sheet after surface treatment, and the recesses have a width in a range of 300 nanometers to 30000 nanometers, and a depth in a range of 100 nanometers to 3000 nanometers. An energy spectrum analysis is performed on the surface of the after-surface-treatment titanium alloy sheet via a scanning electron microscopy so as to measure the concentration of each element and the concentration of an oxygen element on the surface of the titanium alloy sheet after surface treatment. The result is recorded in Table 1.

(3) A composition containing polybutylene terephthalate and glass fiber is injection molded onto surface of the after-surface-treatment titanium alloy sheet obtained after step (2) by using a method same as step (3) of Example 6 so as to obtain a metal-resin composite.

In the composite, an average shearing strength between the metal substrate and the resin layer is listed in Table 2.

TABLE 1

| Concentration | | | | | | | |
|---|---|---|---|---|---|---|---|
| of an oxygen | Example | Example | Example | Example | Example | Example | Example |
| element (wt %) | 1 | 2 | 3 | 4 | 5 | 6 | 7 |
| Prior to surface | 0.15 | 0.15 | 0.15 | 0.15 | 0.15 | 0.18 | 0.18 |
| treatment | | | | | | | |
| After surface | 6.60 | 6.48 | 6.39 | 6.33 | 6.41 | 5.63 | 5.24 |
| treatment | | | | | | | |

TABLE 2

| | Average shearing |
|---|---|
| No. | strength/MPa |
| Example 1 | 18.19 |
| Comparative Example 1 | /* |
| Comparative Example 2 | 9.21 |
| Comparative Example 3 | 7.63 |
| Example 2 | 17.57 |
| Example 3 | 16.96 |
| Example 4 | 15.21 |
| Example 5 | 16.36 |
| Example 6 | 14.32 |
| Example 7 | 12.54 |

*When demolding, the resin layer falls off from the metal substrate.

As we can see from Table 2, with the metal-resin composite of the present disclosure, the average shearing strength between the metal substrate and the resin layer is high, which may indicate that a combination force between the metal substrate and the resin layer is relatively high, thus the metal-resin composite of the present disclosure may have a good structure stability.

1. A metal-resin composite, comprising:
a metal substrate;
a resin layer coated on at least a part of a surface of the metal substrate; and
recesses distributed on the part of the surface of the metal substrate coated with the resin layer, wherein the metal substrate comprises titanium or titanium alloy, a part of resin of the resin layer fills in the recesses, and a concentration of an oxygen element on the surface of the metal substrate is greater than 1 wt %.

2. The composite of claim 1, wherein the recesses have a width of about 10 nanometers to about 100000 nanometers.

3. The composite of claim 1, wherein the concentration of the oxygen element on the surface of the metal substrate is about 1 wt % to about 10 wt.

4. A method of preparing a metal-resin composite from a metal substrate, wherein the metal includes titanium or titanium alloy, the method comprising:
etching the metal substrate by dipping the metal substrate in an etching solution to form recesses on a surface of the metal substrate and obtain an after-surface-treatment metal substrate; and
injection molding a resin-containing composition onto the surface of the after-surface-treatment metal substrate to fill the recesses with resin and form a resin layer, wherein:
the etching solution includes at least one alkali metal hydroxide, an a concentration of an oxygen element on the surface of the after-surface-treatment metal substrate is greater than 1 wt %.

5. The method of claim 4, wherein the alkali metal hydroxide includes sodium hydroxide or potassium hydroxide, and the alkali metal hydroxide has a concentration of about 1 mol/L to about 10 mol/L.

6. The method of claim 4, wherein the etching solution further includes at least one buffering agent with a concentration of about 0.1 mol/L to about 1.5 mol/L, and the buffering agent is configured to stabilize a concentration of a hydroxide ion in the etching solution.

7. The method of claim 6, wherein the buffering agent is at least one selected from a group consisting of boric acid, sodium borate, sodium carbonate, sodium hydrogen carbonate, trisodium phosphate, disodium hydrogen phosphate, and sodium citrate.

8. The method of claim 4, wherein the etching solution has a temperature of about 15 Celsius degrees to about 70 Celsius degrees.

9. The method of claim 4, wherein the recesses have a width of about 10 nanometers to about 100000 nanometers.

10. The method of claim 4, wherein the concentration of the oxygen element on the surface of the after-surface-treatment metal substrate is about 1 wt % to about 10 wt %.

11. A shell of an electronic product, the shell comprising
a metal shell body;
a resin member coated on at least a part of a surface of the metal shell body; and
recesses distributed on the surface of the metal shell body coated with the resin member, wherein the metal shell body is made of titanium or titanium alloy, a part of resin in the resin member fills in the recesses, a concentration of an oxygen element on the surface of the metal shell body coated with the resin member is greater than 1 wt %.

12. The shell of claim 11, wherein the recesses have a width of about 10 nanometers to about 100000 nanometers.

13. The shell of claim 11, wherein the concentration of the oxygen element on the surface of the metal shell body coated with the resin member is about 1 wt % to about 10 wt %.

14. The shell of claim 11, further comprising more than one opening formed on the metal shell body.

15. The shell of claim 14, wherein at least a portion of the opening is corresponding to an installation position of a signal emitting member or a signal receiving member.

16. The shell of claim 14, wherein a resin member is disposed on a position of the opening, and a part of the resin member is filled in the opening.

17. The shell claim 11, wherein the metal shell body includes at least two segments separated from each other, the resin member is disposed on a joint position of two adjacent segments, and the resin member is lap-jointed to the two adjacent segments respectively and covers the joint position.

18. The shell of claim 11, wherein the resin member is coated on at least a part of an outer surface of the metal shell body, and the resin member forms a pattern on the outer surface of the metal shell body.

19. The shell of claim 11, wherein the resin member is coated on an entire inner surface of the metal shell body and has an integrated structure.

20. The shell of claim 11, wherein the electronic product includes a mobile terminal or a wearable electronic device.
